(19) United States
(12) Patent Application Publication
(10) Pub. No.: US 2005/0265760 A1
(43) Pub. Date: Dec. 1, 2005

(54) Image forming apparatus, feeder for image forming apparatus and control method thereof

(75) Inventor: Young-Ho Yoo, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/110,792

(22) Filed: Apr. 21, 2005

(30) Foreign Application Priority Data
May 31, 2004 (KR) 2004-38911

(51) Int. Cl. G03G 15/00

(52) U.S. Cl. 399/361

(57) ABSTRACT

An image forming apparatus, a feeder for an image forming apparatus and control method where: a feeding section feeds loaded papers to a main body of the image forming apparatus; a memory stores driving characteristic data of the feeding section; a function discrimination section discriminates a type of function to be performed by the feeding section; and a controller generates control data for controlling the feeding section to operate according to the discriminated type of function, based on, for example, the driving characteristic data. The control data is stored in a memory, and the driving of the feeding section is controlled by use of the stored control data when an execution command for a certain function is received from a main body control part. The control program, the controller, and the circuit board being utilized in the feeder additionally connected to the image forming apparatus may be generalized, whereby development and manufacture of the feeder may be facilitated.

### CROSS-REFERENCE TO RELATED APPLICATIONS

This application claims the benefit under 35 U.S.C. § 119(a) from Korean Patent Application No. 2004-38911 filed on May 31, 2004 in the Korean Intellectual Property Office, the entire disclosure of which is incorporated herein by reference.

### BACKGROUND OF THE INVENTION

1. Field of the Invention

The present invention relates generally to an image forming apparatus, a feeder for an image forming apparatus and control method thereof. More specifically, the present invention relates to a paper feeder for an image forming apparatus and control method thereof, wherein the paper feeder is connected to the image forming apparatus and feeds documents or prints papers for a main body of the image forming apparatus.

2. Description of the Related Art

An image forming apparatus prints image data, which is created internally or received from an external source, on a print paper. Examples of the image forming apparatus include a photocopier, a printer, a scanner, a facsimile machine, and a multifunction machine which combines functions of such image forming apparatuses into one machine.

A paper feeder is an additional device (optional device) to convey papers in order to a main body of an image forming apparatus. Such a paper feeder includes an automatic document feeder (ADF) and a second cassette feeder (SCF).

The ADF automatically conveys loaded documents in order to the main body to copy or scan the loaded documents in the same order. The SCF conveys print papers having different sizes from general print papers, into the main body.

Both the ADF and the SCF convey papers. To this end, the ADF and the SCF both include sensors for sensing papers, motors for conveying papers, and a clutch for controlling the paper conveyance amount.

The ADF and the SCF further include a control program to control the driving of the parts such as a sensor, a motor and a clutch, a controller to execute the control program, and a circuit board on which the controller and elements are mounted and connected.

However, as the ADF and the SCF perform different functions from each other, the control program, the controller, and the circuit board are totally different. Accordingly, the control program and the like for the ADF need to be developed and implemented separately from the control program and the like for the SCF. To manufacture an additional paper feeder, another control program and the like are required for the additional paper feeder.

That is, if the type of the paper feeder is different, the control program, the controller and the circuit board are different as well, and therefore, are developed and implemented separately. Such developments and implementations cause difficulty in manufacturing the paper feeder.

As aforementioned, the ADF and the SCF are both paper feeders and include analogous parts. If the ADF and the SCF include the same control program, controller, and circuit board, that is, if there is a common control program and the like applicable to all kinds of a paper feeder, it would be much easier to develop and manufacture the paper feeder.

### SUMMARY OF THE INVENTION

The present invention has been developed to address the problems discussed above and other drawbacks associated with the conventional arrangement. An aspect of an embodiment of the present invention provides a paper feeder of an image forming apparatus and control method thereof, which employs a generalized control program, controller, and circuit board to facilitate development and manufacture of the paper feeder.

To achieve an aspect of an embodiment of the present invention, a paper feeder of an image forming apparatus comprises, inter alia, a paper feeding part to feed loaded papers to a main body of the image forming apparatus; a memory part to store driving characteristic data of the paper feeding part; a function discrimination part to discriminate a type of function to be performed by the paper feeding part; and a control part to generate control data for controlling the paper feeding part to operate according to the discriminated function, based on the driving characteristic data. According to an aspect of the invention, the control data is stored in the memory part, and the driving of the paper feeding part is controlled by using the stored control data when an execution command for the certain function is received from a main body control part.

According to an embodiment of the present invention, certain function is either a function for conveying documents to be scanned to the main body or a function for conveying print papers to the main body to print an image on the print papers.

According to another embodiment of the present invention, the received execution command for the certain function contains information relating to a start time, an end time, a speed, and a direction of the paper feeding of the paper feeding part. The control part generates driver data of the paper feeding part based on the information and the control data, and controls the driving of the paper feeding part by use of the generated driver data.

The paper feeding part comprises a motor to rotate a conveying roller which conveys the loaded papers; and a driver to drive the motor by use of the driver data generated in the control part.

According to yet another embodiment of the present invention, the driving characteristic data relate to a driving characteristic and an arrangement of the motor.

According to yet another embodiment of the present invention, the control part sends information relating to the discriminated function to the main body.

According to another aspect of embodiment of the present invention, a control method of a paper feeder having a paper feeding part which feeds loaded papers to a main body of an image forming apparatus, comprises the steps of discriminating a type of function to be performed by the paper feeding part; generating control data for controlling the paper feeding part to operate according to the discriminated function, based on driving characteristic data of the paper feeding part; storing the control data; and controlling the driving of the paper feeding part by use of the stored control data when an execution command for the function is received from a control part of the main body.

According to an embodiment of the present invention, the function is either a function for conveying documents to be scanned to the main body or a function for conveying print papers to the main body to print an image on the print papers.

According to an embodiment of the present invention, the received execution command for the function contains information relating to a start time, an end time, a speed, and a direction of the paper feeding of the paper feeding part. The controlling step generates driver data of the paper feeding part based on the information and the control data, and controls the driving of the paper feeding part by use of the generated driver data.

According to an embodiment of the present invention, the driving characteristic data relate to a driving characteristic and an arrangement of the paper feeding part.

According to an embodiment of the present invention, the control method further comprises the step of sending information relating to the discriminated function to the main body.

According to another embodiment of the present invention, an image forming apparatus, comprising a main body and at least one feeder which is removably or fixedly attached to the main body. The at least one feeder comprises: a feeding section which feeds at least one sheet of a recordable medium to the main body; a memory which stores driving characteristic data of the feeding section; a function discrimination section which discriminates a type of function to be performed by the feeding section; and a controller which generates control data for controlling the feeding section to operate according to the type of function discriminated by the function discrimination section, based on the driving characteristic data. The control data may be stored in the memory, and the driving of the feeding section is controlled at least in part with reference to the control data stored in the memory when an execution command for the type of function to be performed is received from the main body.

### BRIEF DESCRIPTION OF THE DRAWING FIGURES

These and/or other aspects and advantages of the invention will become apparent and more readily appreciated from the following description of exemplary embodiments, taken in conjunction with the accompanying drawing figures of which:

FIG. 1 is a block diagram of a paper feeder of an image forming apparatus according to an exemplary embodiment of the present invention;

FIG. 2 is a block diagram of a paper feeding part of FIG. 1;

FIG. 3 is a block diagram of an exemplary image forming apparatus implemented by connecting exemplary designs of automatic document feeder (ADF) and a second cassette feeder (SCF) according to an exemplary embodiment of the present invention; and

FIG. 4 is a flowchart of an example of a control method of the paper feeder according to an exemplary embodiment of the present invention.

Throughout the drawing figures, like reference numbers will be understood to refer to like elements, features and structures.

### DETAILED DESCRIPTION OF EXAMPLARY EMBODIMENT

Reference will now be made in detail to various non-limiting embodiments of the present invention, examples of which are illustrated in the accompanying drawings, wherein, as noted above, like reference numerals refer to the like elements throughout. The embodiments are described below in order to explain exemplary implementations of the present invention by referring to the drawings.

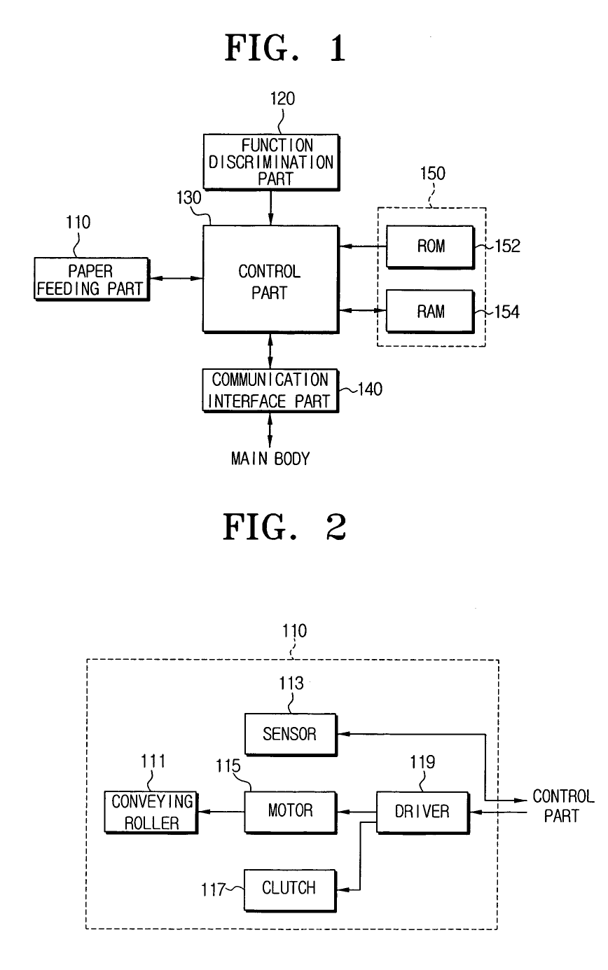

FIG. 1 is a block diagram of a paper feeder of an image forming apparatus according to an exemplary embodiment of the present invention. The paper feeder of FIG. 1 is an additional device (optional device) connectable to a main body of an image forming apparatus. The paper feeder includes a paper feeding part 110, a function discrimination part 120, a control part 130, a communication interface part 140, and a memory part 150.

The paper feeding part 110 conveys loaded paper stack in sequence to the main body. In the event that the paper feeder of FIG. 1 is an automatic document feeder (ADF), the paper feeding part 110 automatically conveys the loaded paper stack in order to the main body so as to scan the papers in the same order in the main body. If the paper feeder of FIG. 1 is a second cassette feeder (SCF), the paper feeding part 110 conveys the loaded paper stack to the main body so as to print an image on papers.

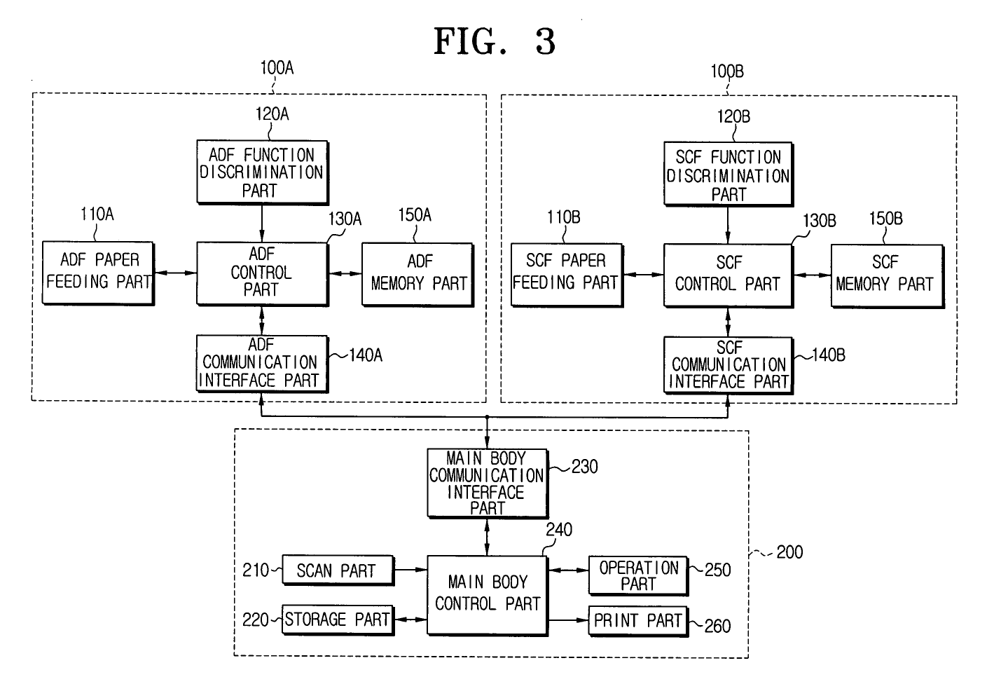

FIG. 2 is a block diagram of the paper feeding part 110 of FIG. 1. Referring to FIG. 2, the paper feeding part 110 includes a conveying roller 111, a sensor 113, a motor 115, a clutch 117, and a driver 119.

The sensor 113 detects whether a paper stack is loaded in the paper feeding part 110. The conveying roller 111 conveys the loaded papers by rotating in relation with the motor 115. The clutch 117 controls feeding amount of the papers. The driver 119 drives the motor 115 and the clutch 117.

Type and arrangement of the conveying roller 111, the sensor 113, the motor 115, and the clutch 117 may differ depending on a type of the paper feeder. To be specific, if the paper feeder is the ADF or the SCF, parts of the paper feeding part 110 differ in the type and the arrangement accordingly.

Referring back to FIG. 1, the function discrimination part 120 discriminates a type of the paper feeder through a certain detecting operation upon the connection of the paper feeder to the main body, and notifies the discrimination to the control part 130. That is, the function discrimination part 120 discriminates and notifies the control part 130 of a function for the paper feeder to perform with respect to the main body.

The function discrimination part 120 may be implemented to generate a different discrimination signal depending on the type of the paper feeder (for example, a logic level ‘high’ signal for the ADF and a logic level ‘low’ signal for the SCF) and apply the discrimination signal to a specific port of the control part 130.

The memory part 150 is a recording medium to store programs and data required to drive the paper feeder. The memory part 150 includes a read only memory (ROM) 152 and a random access memory (RAM) 154.

The ROM 152 stores a control program to be executed by the control part 130 and driving characteristic data of the paper feeding part 110. The RAM 154 stores control data of the paper feeding part 110, which are generated based on the driving characteristic data by the control part 110.

The control part 130 uses the control program to generate the control data and to control the paper feeding part 110 accordingly. The same control program may be used regardless of the type of the paper feeder such as an ADF and a SCF.

The driving characteristic data relate to driving characteristics and arrangements (for example, distances between parts) of the conveying roller 111, the sensor 113, the motor 115, and the clutch 117 of the paper feeding part 110. The driving characteristic data differ depending on the type of the paper feeder. Accordingly, the control data, which is generated based on the driving characteristic data, also differ depending on the type of the paper feeder.

The control part 130 controls the paper feeding part 110 to operate in accordance with the function discriminated by the function discrimination part 120. The control part 130 executes the control program to perform the above operation.

In further detail, the control part 130 generates and stores the control data in the RAM 154 by use of the driving characteristic data stored in the ROM 152. The control data are used to control the paper feeding part 110 to operate in accordance with the discriminated function.

The control part 130 communicates data with a main body control part (not shown) of the main body 200 (see FIG. 3) through the communication interface part 140. The control part 130 transmits information on the discriminated function to the main body control part (not shown), and performs a command received from the main body control part (not shown).

The following example describes an implementation of an embodiment of the invention where an image forming apparatus comprises an ADF and a SCF, which are exemplary paper feeders, connected to a main body, as illustrated in FIG. 3.

In FIG. 3, the image forming apparatus includes the main body 200, the ADF 100A, and the SCF 100B. The ADF 100A and the SCF 100B respectively are connected to the main body 200.

The ADF 100A includes an ADF paper feeding part 110A, an ADF function discrimination part 120A, an ADF control part 130A, an ADF communication interface part 140A, and an ADF memory part 150A. The SCF 100B includes a SCF paper feeding part 110B, a SCF function discrimination part 120B, a SCF control part 130B, a SCF communication interface part 140B, and a SCF memory part 150B.

Functions of the parts of the ADF 100A and the SCF 100B are identical with those of the paper feeder of FIG. 1, which are not explained for conciseness.

The ADF function discrimination part 120A, the ADF control part 130A, the ADF communication interface part 140A, and the ADF memory part 150A may be the same as the SCF function discrimination part 120B, the SCF control part 130B, the SCF communication interface part 140B, and the SCF memory part 150B, respectively. An ADF control program used by the ADF control part 130A may be the same as a SCF control program used by the SCF control part 130B.

Both the ADF paper feeding part 110A and the SCF paper feeding part 110B convey the loaded papers to the main body, and include a conveying roller, a sensor, a motor, a clutch, and a driver, respectively (FIG. 2).

A difference lies in that the ADF paper feeding part 110A conveys loaded documents in order to the main body while the SCF paper feeding part 110B conveys loaded print papers to the main body. Hence, the ADF paper feeding part 110A and the SCF paper feeding part 110B have different types and arrangements of the sensor, the motor, the clutch and the like.

As constructed above, the ADF driving characteristic data of the ADF paper feeding part 110A stored in the ADF memory part 150A is different from the SCF driving characteristic data of the SCF paper feeding part 110B stored in the SCF memory part 150B. The ADF control data generated based on the ADF driving characteristic data is also different from the SCF control data generated based on the SCF driving characteristic data.

The main body 200 includes a scan part 210, a storage part 220, a main body communication interface part 230, a main body control part 240, an operation part 250, and a print part 260.

The scan part 210 generates image data by scanning documents conveyed by the ADF 100A. The storage part 220 is a recording medium to store the image data generated by the scan part 210, a print data transmitted from a personal computer (not shown), and a driver program. The print part 260 prints the image data and the print data stored in the storage part 220 onto print papers fed by the SCF 100B.

The operation part 250 can be implemented with a key input device and a liquid crystal display (LCD). The key input device receives and sends a user's command to the main body control part 250. The LCD displays operation state and guide information of the image forming apparatus. The main body communication interface part 230 communicates data with the ADF 100a and the SCF 100b.

The main body control part 240 controls scan operation and print operation of the image forming apparatus. During the scan operation, the main body control part 240 controls the scan part 210 and sends a control command to the ADF control part 130a to convey documents to the scan part 210. During the print operation, the main body control part 240 controls the print part 260 and sends a control command to the SCF control part 130b to convey print papers to the print part 260.

When sending the control command to the ADF control part 130A and the SCF control part 130B, the main body control part 240 assigns a control part to receive the control command in a header of the control command. The ADF control part 130A and the SCF control part 130B receive only a corresponding control command in reference to the header of the control command.

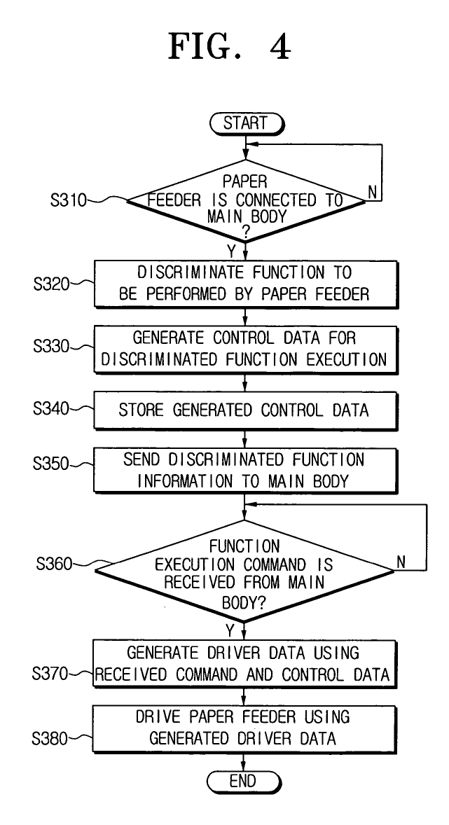

An example of a control method of a paper feeder according to an embodiment of the present invention in described below with reference to FIG. 4.

When a paper feeder is connected to the main body 200 (S310), the function discrimination part 120 of the paper feeder discriminates the type of the paper feeder through a detecting operation by discriminating, for example a function to be performed by the paper feeder with regard to the main body 200 (S320). The result of the discrimination is communicated to the control part 130. To this end, the function discrimination part 120 may generate a different discrimination signal depending on the type of the paper feeder (for example, a logic level ‘high’ signal for the ADF 100A and a logic level ‘low’ signal for the SCF 100B), and apply the discrimination signal to a specific port of the control part 130.

The control part 130 generates the control data required to control the paper feeding part 110 so as to perform the function discriminated at step S320 (S330). The control part 130 stores the generated control data in the RAM 154 (S340). The control data includes information for controlling the paper feeding part 110 to operate in accordance with the function discriminated by the function discrimination part 120.

The control part 130 generates the control data by use of the driving characteristic data stored in the ROM 152. The driving characteristic data relate to operational characteristics and arrangement of the conveying roller 111, the sensor 113, the motor 115, and the clutch 117 of the paper feeding part 110. The driving characteristic data differ depending on the type of the paper feeder. Accordingly, the control data, which is generated based on the driving characteristic data, also differ depending on the type of the paper feeder.

The control part 130 transmits the information on the discriminated function to the main body 200 through the communication interface part 140 (S350). Accordingly, the main body control part 240 may have information as to which paper feeder is connected to the main body 200.

Next, upon receiving a function execution command from the main body control part 240 (S360), the control part 130 generates driver data of the paper feeding part 110 by use of the received command and the control data (S370).

For example, if the paper feeder is the ADF 100A, the ADF control part 130a receives a command to convey the documents as the image forming apparatus performs the scan operation. If the paper feeder is the SCF 100B, the SCF control part 130b receives a command to convey the print papers as the image forming apparatus performs the print operation.

The function execution command contains information relating to a start time, an end time, a speed, and a direction of the paper feeding of the paper feeding part 110. The control part 130 generates driver data based on the received information and the control data stored in the RAM 154.

The control part 130 drives the paper feeding part 100 by use of the generated driver data (S380). For example, when the control part 130 applies the generated driver data to the driver 119 of the paper feeding part 110, the driver 119 drives the motor 115 and the clutch 117 using the applied driver data. As a result, the papers are conveyed and fed to the image forming apparatus.

In the above-described exemplary embodiment of the present invention, the paper feeders for the image forming apparatus are exemplified by the ADF and the SCF. It is to be understood that the present invention can be applied to any device capable of conveying papers into the main body of the image forming apparatus. For example, the present invention may be applied to a duplex ADF which feeds documents to scan both sides of the documents.

In light of the foregoing as mentioned above, it is possible to generalize the control program, the controller, and the circuit board being utilized in the paper feeder additionally connected to the image forming apparatus. Hence, the development and the manufacture of the paper feeder are facilitated.

While the exemplary embodiments of the present invention have been described, additional variations and modifications of the embodiments may occur to those skilled in the art. For example, a skilled artisan may appreciate that not only “paper feeders”, but feeders of other types of recordable media, such as transparencies, slides, etc., may be implemented in a manner exemplified above. Therefore, it is intended that the appended claims shall be construed to include, inter alia, the above-described exemplary embodiments and all such variations and modifications that fall within the spirit and scope of the invention.

1. A feeder for an image forming apparatus, comprising:
a feeding section which feeds at least one sheet of recordable medium to an image forming apparatus;
a memory which stores driving characteristic data of the feeding section;
a function discrimination section which discriminates a type of function to be performed by the feeding section; and
a controller which generates control data for controlling the feeding section to operate according to the type of function discriminated by the function discrimination section, based on the driving characteristic data;
wherein the control data is stored in the memory, and the driving of the feeding section is controlled at least in part with reference to the control data stored in the memory when an execution command for the type of function is received from the image forming apparatus.

2. The feeder according to claim 1, wherein the type of function comprises at least one of a function for conveying at least one sheet of documents to be scanned to the image forming apparatus and a function for conveying at least one sheet of papers to the image forming apparatus.

3. The feeder according to claim 1, wherein:
the received execution command for the type of function comprises information relating to at least one of a start time, an end time, a speed, and a direction of feeding of the feeding section; and
the controller generates driver data for the feeding section based at least in part on the information and the control data, and controls the driving of the feeding section at least in part with reference to the driver data.

4. The feeder according to claim 3, wherein the feeder comprises:
a motor which rotates a conveying roller which conveys the at least one sheet of the recordable medium; and
a driver which drives the motor based at least in part on the driver data generated by the control part.

5. The feeder according to claim 4, wherein the driver data relate at least in part to a driving characteristic and an arrangement of the motor.

6. The feeder according to claim 1, wherein the controller sends information relating to the discriminated type of function to the image forming apparatus.

7. A control method for a feeder comprising a feeding section which feeds at least one sheet of recordable medium to an image forming apparatus, the control method comprising:
discriminating a type of function to be performed by the feeding section;
generating control data for controlling the feeding section to operate according to the discriminated type of function, based on driving characteristic data of the feeding section;
storing the control data; and
controlling the driving of the feeding section at least in part with reference to the stored control data when an execution command for the type of function is received from the image forming apparatus.

8. The control method according to claim 7, wherein the type of function comprises at least one of a function for conveying at least one sheet of documents to be scanned to the image forming apparatus and a function for conveying at least one sheet of papers to the image forming apparatus.

9. The control method according to claim 7, wherein:
the received execution command for the function comprises information relating to at least one of a start time, an end time, a speed, and a direction of feeding of the feeding section; and
the controlling of the driving of the feeding section comprises generating driver data of the feeding section based at least in part on the information and the control data, and controlling the driving of the feeding section at least in part with reference to the generated driver data.

10. The control method according to claim 7, wherein the driver data relate at least in part to a driving characteristic and an arrangement of the feeding section.

11. The control method according to claim 7, further comprising sending information relating to the discriminated type of function to the image forming apparatus.

12. The feeder according to claim 1, wherein the recordable medium comprises at least one of: paper, transparency, and photo paper.

13. The control method according to claim 7, wherein the recordable medium comprises at least one of: paper, transparency, and photo paper.

14. An image forming apparatus, comprising:
a main body; and
a first feeder removably or fixedly attached to the main body;
wherein the first feeder comprises:
a first feeding section which feeds at least one sheet of a first recordable medium to the main body,
a first memory which stores first driving characteristic data of the first feeding section;
a first function discrimination section which discriminates a first type of function to be performed by the first feeding section; and
a first controller which generates first control data for controlling the first feeding section to operate according to the first type of function discriminated by the first function discrimination section, based on the first driving characteristic data;
wherein the first control data is stored in the first memory, and the driving of the first feeding section is controlled at least in part with reference to the first control data stored in the first memory when an execution command for the first type of function is received from the main body.

15. The image forming apparatus according to claim 14, further comprising a second feeder removably or fixedly attached to the main body;
wherein the second feeder comprises:
a second feeding section which feeds at least one sheet of a second recordable medium to the main body;
a second memory which stores second driving characteristic data of the second feeding section;
a second function discrimination section which discriminates a second type of function to be performed by the second feeding section; and
a second controller which generates second control data for controlling the second feeding section to operate according to the second type of function discriminated by the second function discrimination section, based on the second driving characteristic data;
wherein the second control data is stored in the second memory, and the driving of the second feeding section is controlled at least in part with reference to the second control data stored in the second memory when an execution command for the second type of function is received from the main body.

16. The image forming apparatus according to claim 14, wherein the first type of function comprises at least one of: a function for conveying at least one sheet of documents to be scanned to the image forming apparatus; and a function for conveying at least one sheet of papers to the image forming apparatus.

17. The image forming apparatus according to claim 15, wherein at least one of the first and second type of function comprises at least one of: a function for conveying at least one sheet of documents to be scanned to the image forming apparatus; and a function for conveying at least one sheet of papers to the image forming apparatus.

18. The image forming apparatus according to claim 15, wherein the first type of function is different from the second type of function.

19. The image forming apparatus according to claim 14, wherein the main body comprises a main body controller which supplies the execution command for the first type function to the first feeder.

20. The image forming apparatus according to claim 15, wherein the main body comprises a main body controller which supplies at least one of the execution command for the first type function to the first feeder and the execution command for the second type function to the second feeder.

21. The image forming apparatus according to claim 20, wherein the execution command for the first type function is a scan command and the execution command for the second type function is a print command.
